(19) United States
(12) Patent Application Publication
(10) Pub. No.: US 2025/0041771 A1
(43) Pub. Date: Feb. 6, 2025

(54) FILTER ELEMENT WITH VALVE DEVICE

(71) Applicant: MANN+HUMMEL GmbH, Ludwigsburg (DE)

(72) Inventors: Mike MÄRTZ, Harthausen (DE); Tomás VALOUSEK, Syrovice (CZ)

(21) Appl. No.: 18/926,380

(22) Filed: Oct. 25, 2024

Related U.S. Application Data
(63) Continuation of application No. PCT/EP2023/055386, filed on Mar. 3, 2023.

(30) Foreign Application Priority Data
Apr. 25, 2022 (DE) 102022109929.6

(51) Int. Cl. B01D 29/21; B01D 29/92; B01D 35/153

(52) U.S. Cl. CPC B01D 29/213; B01D 29/925; B01D 35/153; B01D 2201/167; B01D 2201/291; B01D 2201/4007

(57) ABSTRACT

A fluid filter element has a hollow-cylindrical filter bellows arranged at a central tube with longitudinal axis and can be flowed through by fluid from a radially outward raw fluid side to a radially inward clean fluid side. First and second end disks close off the filter bellows at first and second end faces. The first end disk has an opening with a valve device arranged inside the central tube and openable from the raw fluid side by hydraulic pressure. The valve device has a valve body and a valve cage with a screen arranged thereat. The valve body is movable in the valve cage along the longitudinal axis and forced by a spring against a valve seat of the valve cage. The screen separates the valve device interior from the clean fluid side. The valve cage is arranged at a support body connected to the central tube.

### CROSS-REFERENCE TO RELATED APPLICATIONS

This application is a continuation application of international application No. PCT/EP2023/055386 having an international filing date of Mar. 3, 2023, and designating the United States, the international application claiming a priority date of Apr. 25, 2022, based on prior filed German patent application No. 10 2022 109 929.6, the entire contents of the aforesaid international application and the aforesaid German patent application being incorporated herein by reference.

### BACKGROUND

The application concerns a filter element for filtering a fluid, in particular a liquid, in particular for filtering hydraulic liquid or motor oil, with a hollow-cylindrical filter bellows to be flowed through radially.

DE 10 2010 054 349 A1 discloses an exchangeable filter element for filtering a liquid, in particular for filtering the oil of an oil circuit of an internal combustion engine. The filter element comprises a filter bellows for the passage of the liquid to be filtered as well as a cylindrical central tube for supporting the filter insert. At the central tube, a screen is arranged that closes off the terminal opening of the filter element and wherein the screen comprises a screen body which is connected along its circumference seal-tightly to the central tube or to the end disk.

US 2013/0327429 A1 discloses a bypass valve with adjustable flow resistance for a device flowed through by a liquid medium, for example, a filter element. The valve comprises a seat and a body which is pretensioned when closed and which is movable by a fluid medium pressure differential between the inflow side and the outflow side of the valve in opening direction when the pressure differential surpasses a threshold value. A bypass flow path connects the inflow side to the outflow side through the seat. The bypass valve comprises a screen arranged in the bypass flow path. The valve body has two different open positions which depend on the pressure differential of the fluid medium. The entire cross section of the bypass flow path is covered by the screen in a first valve body open position at a minimal pressure differential and is released with a screen-free bypass flow path cross section in a second valve body open position at a greater pressure differential.

### SUMMARY

It is an object to provide a cost-efficient filter element with a valve device and a screen.

The aforementioned object may be solved, for example, by a filter element for filtering a fluid, in particular a liquid, comprising at least one hollow-cylindrical filter bellows to be flowed through radially, which is arranged at a central tube with a longitudinal axis and which can be flowed through by the fluid from a radially outwardly positioned raw fluid side to a radially inwardly positioned clean fluid side, wherein the filter bellows is closed off at a first end face by a first end disk and at a second end face by a second end disk, wherein the first end disk comprises an opening with a valve device which is arranged inside of the central tube and which can be opened from the raw fluid side by a hydraulic pressure, wherein the valve device comprises a valve body and a valve cage as well as a screen, wherein the valve body is movable in the valve cage along the longitudinal axis and, in a pressureless state, is forced by means of a spring against a valve seat arranged in the valve cage, wherein the screen is arranged at the valve cage and the screen separates an interior of the valve device from the clean fluid side, wherein the valve cage is arranged at a support body which is connected to the central tube.

Beneficial embodiments and advantages may result from the additional claims, the description, and the drawing.

According to an embodiment, a filter element for filtering a fluid, in particular a liquid, is proposed, comprising at least one hollow-cylindrical filter bellows to be flowed through radially, which is arranged at a central tube with a longitudinal axis and which can be flowed through by the fluid from a radially outwardly positioned raw fluid side to a radially inwardly positioned clean fluid side. The filter bellows is closed off at a first end face by a first end disk and at a second end face by a second end disk. The first end disk comprises an opening with a valve device which is arranged inside of the central tube and which can be opened from the raw fluid side by a hydraulic pressure. The valve device comprises a valve body and a valve cage as well as a screen, wherein the valve body is movable in the valve cage along the longitudinal axis and, in a pressureless state, is forced by means of a spring against a valve seat arranged in the valve cage. The screen is arranged at the valve cage and separates an interior of the valve device from the clean fluid side. The valve cage is arranged at a support body connected to the central tube.

Advantageously, the valve device separates the raw fluid side from the clean fluid side of the filter element.

The filter element can be installed exchangeably in a filter housing or fixedly in a so-called spin-on filter system. The filter element comprises a filter bellows, two end disks, a central tube, as well as a valve device as bypass valve which forms at the same time a safety screen component group with a screen. The filter element is flowed through in radial direction from the exterior to the interior by the fluid to be filtered. Beginning at a defined pressure differential, the bypass valve opens. In this context, a valve body is lifted off by the fluid pressure from a valve seat and is forced against a spiral spring. The screen of fabric is cylindrical and can be produced at least partially molded over in a valve cage during a casting process.

The screen can be produced from a conventional screen fabric. For example, plastic material screens or metal screens are possible. Also, a nonwoven can be used, for example. A mesh width can lie advantageously between 100 om and 500 Φm, for example.

Due to the integration of valve device and screen, the filter element can be produced advantageously less expensively because bonding processes can be performed more beneficially with less material input. Beneficially, components can be saved or can be produced less expensively. Due to plug-in connections or detent connections of the valve device to the central tube and/or to the end disk as connecting processes, a reusability of components can be achieved. Components are more easily accessible and, in this way, costs can be saved in the production process.

According to a beneficial embodiment of the filter element, the support body and the central tube can be formed together as one piece. In this way, production costs in the production of both components can be more beneficially designed.

According to a beneficial embodiment of the filter element, the valve cage can be connected to the central tube and/or to the support body by means of a detent connection and/or a snap connection and/or a plug-in connection and/or a screw connection. By use of such connecting processes, the valve cage can also be demounted again without being destroyed so that a reusability in case of maintenance is ensured.

According to a beneficial embodiment of the filter element, the valve cage can comprise guide elements at its inner side for axial guiding of the valve body. In this manner, a safe function of the valve body can be achieved advantageously.

According to a beneficial embodiment of the filter element, a gap between the screen and an outer diameter of the valve body can be formed. In this way, it can be ensured that the movement clearance of the valve body for its function is not impaired by the screen.

According to a beneficial embodiment of the filter element, the valve cage can be pressed and/or glued and/or screwed into the opening of the first end disk. In this manner, a safe and permanent connection of the valve cage to the first end disk can be achieved.

According to a beneficial embodiment of the filter element, the valve cage and the first end disk can be formed together as one piece. In this way, end disk and valve cage can be beneficially produced in one production step, for example, by injection molding of plastic material. As material, advantageously polyamide (PA) can be used, for example. For higher strength, also a fiber-reinforced plastic material can be used.

According to a beneficial embodiment of the filter element, the filter bellows and/or the central tube can be glued to the end disks. In particular, the filter bellows and/or the central tube can be embedded by means of a liquid adhesive in the end disks which are comprised of a hard plastic material, for example, PA. Such a bonding process ensures a safe and reliable connection of filter bellows and/or central tube to the end disks and also represents a cost-efficient production process.

According to a beneficial embodiment of the filter element, the filter element with the valve device can be operated opposite to a direction of gravity. In this way, the filter element, depending on the application, can also be operated upside down.

According to a beneficial embodiment of the filter element, at least the first end disk can be configured as a film end disk and the central tube and/or the valve cage can be connected by means of a plug-in connection to the first end disk. Film end disks represent a cost-efficient alternative for producing plastic end disks in filter elements.

According to a beneficial embodiment of the filter element, the plug-in connection can be detachable. In this way, advantageously a reuse of the individual components can be ensured.

According to a beneficial embodiment of the filter element, the valve cage can be configured as a hollow cylinder with through openings which are covered by the screen. In this way, when the valve body releases the valve passage upon excess fluid pressure, the fluid, filtered by the screen, can flow in a beneficial manner into the interior of the filter element which represents the clean fluid region of the filter element.

According to a beneficial embodiment of the filter element, the support body can comprise ribs extending in the axial direction which serve for guiding the valve cage. In this way, a reliable mounting of the valve cage at the support body is possible because the valve cage, for example, is advantageously centered by the ribs during mounting.

According to a beneficial embodiment of the filter element, the support body can comprise a circumferentially extending shoulder as a spring support which serves for supporting the spring when the valve device is mounted as intended. In this way, a safe seat of the spring in operation of the filter element can be achieved whereby the reliable function of the valve device can be ensured.

According to a beneficial embodiment of the filter element, the support body can be connected by radially extending ribs to the central tube. Due to the connection of the support body to the central tube by individual ribs, it can be achieved that a free fluid flow of the fluid filtered by the screen into the clean fluid region of the filter element is provided.

### BRIEF DESCRIPTION OF DRAWINGS

Further advantages result from the following drawing description. In the drawings, embodiments are illustrated. The drawings, the description, and the claims contain numerous features in combination. A person of skill in the art will consider the features expediently also individually and combine them to expedient further combinations.

FIG. 1 shows a partially sectioned side view of the filter element for filtering a fluid, in particular a liquid, according to an embodiment.

FIG. 2 shows a sectioned isometric illustration of the filter element according to FIG. 1.

FIG. 3 shows an enlarged illustration of a valve device of the filter element without filter bellows.

FIG. 4 shows a valve cage of the filter element according to FIG. 1 in isometric illustration.

### DETAILED DESCRIPTION

In the Figures, same or same-type components are identified with same reference characters. The Figures show only examples and are not to be understood as limiting.

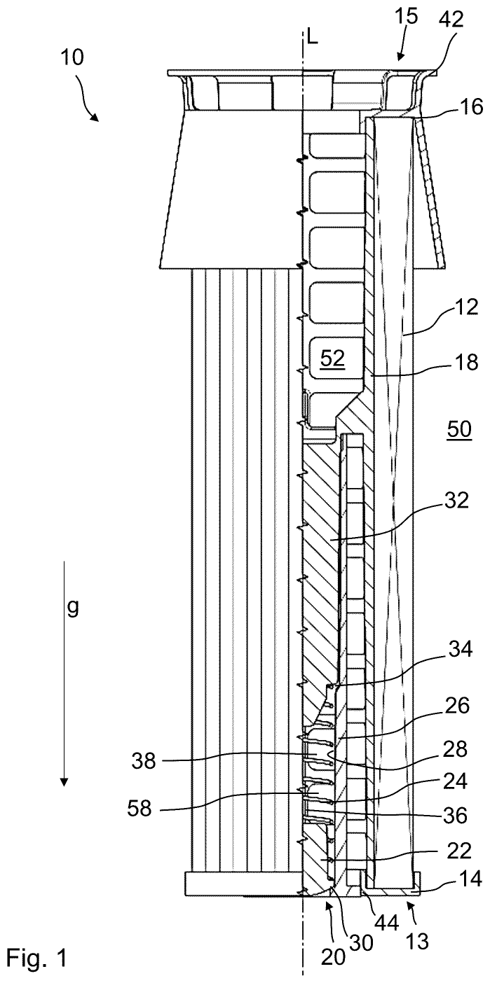

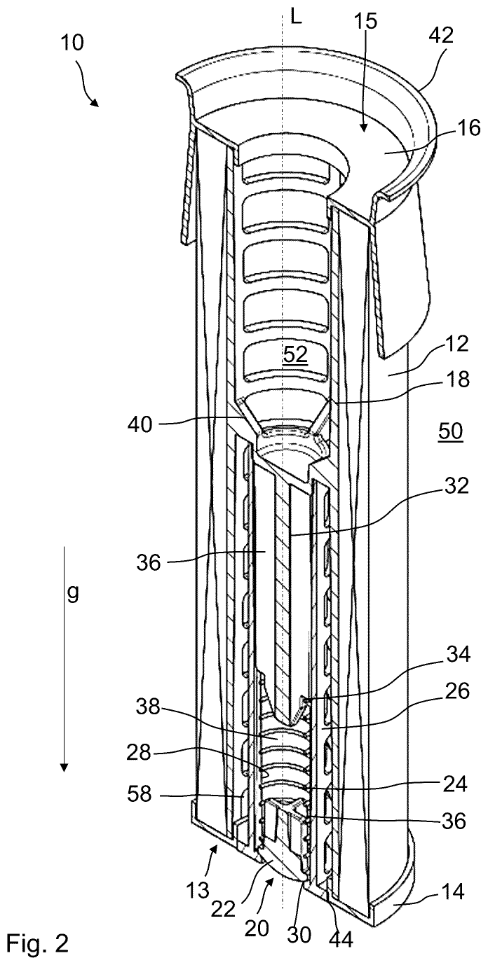

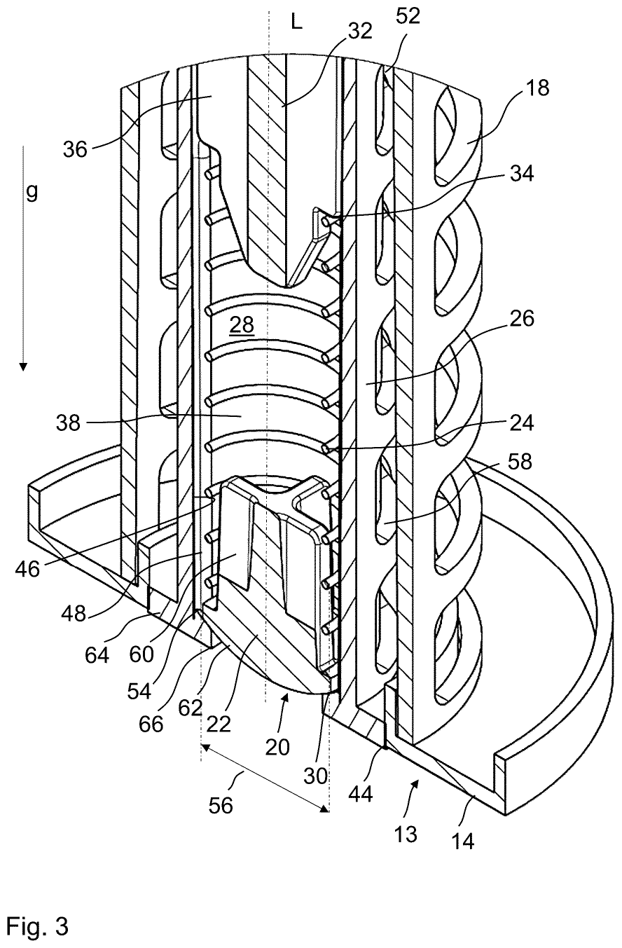

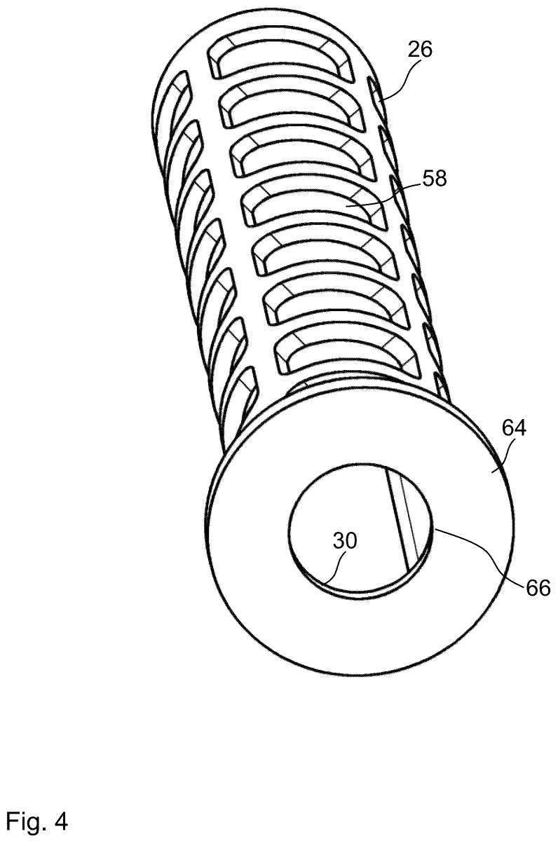

FIG. 1 shows a partially sectioned side view of a filter element 10 for filtering a fluid, in particular a liquid, according to an embodiment while in FIG. 2 a sectioned isometric illustration of the filter element 10 according to FIG. 1 is illustrated. FIG. 3 shows in this respect an enlarged illustration of a valve device 20 of the filter element 10 without filter bellows 12. In FIG. 4, a valve cage 26 of the filter element 10 according to FIG. 1 is shown in isometric illustration.

The filter element 10 comprises a hollow-cylindrical filter bellows 12 to be flowed through radially and which is arranged at a central tube 18 with a longitudinal axis L. The filter bellows 12, in operation as intended, is flowed through by the fluid from a radially outwardly positioned raw fluid side 50 to a radially inwardly positioned clean fluid side 52. The filter bellows 12 is closed off at a first end face 13 by a first end disk 14 and at a second end face 15 by a second end disk 16. The second end disk 16 comprises a collar-shaped bulge 42 which ensures a sealing action between the raw fluid side 50 and the clean fluid side 52 upon installation in a non-illustrated filter housing.

The first end disk 14 comprises an opening 44 with a valve device 20 which is arranged inside of the central tube 18. The valve device 20 comprises a valve body 22 and a valve cage 26 as well as a screen 28. The valve body 22 can move in the valve cage 26 along the longitudinal axis L and, in a pressureless state, is forced by means of a spring 24 against a valve seat 30 arranged in the valve cage 26. Accordingly, the valve device 20 constitutes a check valve.

The valve body 22 comprises a valve cone 62 which seals in relation to the valve seat 30 and which is connected to four vane-type ribs 60 which are arranged in a cross shape, which can be seen in particular in FIG. 3. For example, the valve cone 62 can be formed as part of a truncated cone or as part of a spherical cap in order to ensure a reliable sealing action at the valve seat 30.

As can be seen in FIGS. 3 and 4, the valve seat 30 is arranged at the side of an opening 66 of a closure plate 64 of the valve cage 26, which side faces the interior 38 of the valve device 20.

The screen 28 is arranged at the valve cage 26 and separates an interior 38 of the valve device 20 from the clean fluid side 52. The valve cage 26 is arranged at a support body 32 connected to the central tube 18.

The valve device 20 separates the raw fluid side 50 from the clean fluid side 52 and can be opened from the raw fluid side 50 by a hydraulic pressure. The valve device 20 functions thus as a bypass valve in case the hydraulic pressure at the raw fluid side 50 is too great. In this case, the valve device 20 opens and raw fluid can flow into the interior 38 of the valve device 20.

The support body 32 can be configured together with the central tube 18 as one piece, as can be seen in the embodiment illustrated in section view in FIG. 1 and can be connected to the central tube 18 by radially extending ribs 40, as can be seen in FIG. 2.

The valve cage 26, which is formed as a hollow cylinder with through openings 58, as can be seen in particular in FIGS. 3 and 4, comprises at an inner side 46 the screen 28. In this context, at least the through openings 58 can be covered by the screen 28.

When mounting the valve device 20, the valve cage 26 with inserted valve body 22 and spring 24 arranged on top can be plugged onto the pin-shaped support body 32 through the opening 44 of the first end disk 14.

For this purpose, the support body 32, as can be seen in regard to the illustrated embodiment in particular in FIG. 3, can comprise a circumferentially extending shoulder 34 as spring support which serves for supporting the spring 24 when the valve device 20 is mounted as intended. Due to the shoulder 34, the spring 24 can advantageously be embodied shorter.

Furthermore, the support body 32 can have ribs 36 extending in the axial direction L which serve for guiding the valve cage 26 during plugging on and in addition represent a firm fixation of the valve cage 26 in radial direction which is advantageous for a robust operation of the filter element. The illustrated embodiment comprises, for example, four ribs 36 which, in cross section, are arranged in a cross shape. In the illustrations of FIGS. 1 to 3, only two ribs 36 can be seen, respectively. A third rib 36 is shown in section. The fourth rib 36 cannot be seen in the illustrations.

Accordingly, the valve cage 26 can be connected to the central tube 18 and/or to the support body 32 at least by means of a detent connection and/or a snap connection and/or a plug-in connection and/or a screw connection.

In this context, the valve cage 26 can be pressed and/or glued and/or screwed into the opening 44 of the first end disk 14.

In an alternative embodiment, the valve cage 26 and the first end disk 14 can be formed together as one piece.

The valve cage 26 comprises at its inner side 46 guide elements 48 for axial guiding of the valve body 22. These guide elements 48, which can be formed as ribs, can serve also advantageously for stiffening the valve cage 26. In addition, a gap 54 can be formed beneficially between the screen 28 and an outer diameter 56 of the valve body 22.

The filter bellows 12 and/or the central tube 18 can be glued advantageously to the end disks 14, 16, which can be formed, for example, of plastic material. For example, the filter bellows 12 and/or the central tube 18 can be embedded by means of a liquid adhesive in the end disks 14, 16. When the end disks 14, 16 are formed as solid end disks 14, 16, filter bellows 12 and central tube 18 can also be embedded advantageously with polyurethane (PU), for example.

In an alternative embodiment, at least the first end disk 14 can also be formed as a film end disk. In this context, the central tube 18 and/or the valve cage 26 can be connected by a plug-in connection to the at least one first end disk 14. In such an embodiment, the rigid end disks 14, 16 of the embodiment illustrated in FIGS. 1 to 3 are dispensed with.

For example, the plug-in connections of central tube 18 and/or valve cage 26 can be detachably designed. In this way, advantageously a reuse of these inner components of the filter element 10 in a maintenance situation can be ensured, for example, in case of an exchange due to a loaded filter bellows 12.

In the embodiments illustrated in FIGS. 1 through 4, the filter element 10 is oriented respectively such that the valve device 20 is arranged at the bottom in the direction of gravity g. In principle, it is however also possible that the filter element 10 with the valve device 20 is operated opposite to the direction of gravity g.

### REFERENCE CHARACTERS

10 filter element
12 filter bellows
13 first end face
14 first end disk
15 second end face
16 second end disk
18 central tube
20 valve device
22 valve body
24 spring
26 valve cage
28 screen
30 valve seat
32 support body
34 shoulder
36 rib
38 interior
40 rib
42 collar-shaped bulge
44 opening
46 inner side
48 guide element
50 raw fluid side
52 clean fluid side
54 gap
56 outer diameter
58 through opening
60 vane
62 valve cone
64 closure plate
66 opening
L axial direction
g direction of gravity

What is claimed is:

1. A filter element for filtering a fluid, the filter element comprising:
a central tube with a longitudinal axis;
at least one hollow-cylindrical filter bellows arranged at the central tube and configured to be flowed through radially by the fluid from a radially outwardly positioned raw fluid side to a radially inwardly positioned clean fluid side;
a first end disk closing off the at least one hollow-cylindrical filter bellows at a first end face thereof;
a second end disk closing off the at least one hollow-cylindrical filter bellows at a second end face thereof;
a support body connected to the central tube;
wherein the first end disk comprises an opening with a valve device arranged inside the central tube;
wherein the valve device is configured to be opened from the raw fluid side by a hydraulic pressure of the fluid;
wherein the valve device comprises a valve body, a valve cage, and a screen;
wherein the valve body is movable in the valve cage along the longitudinal axis;
wherein the valve body, in a pressureless state, is forced by a spring against a valve seat arranged in the valve cage;
wherein the screen is arranged at the valve cage and the screen separates an interior of the valve device from the radially inwardly positioned clean fluid side;
wherein the valve cage is arranged at the support body.

2. The filter element according to claim 1, wherein the support body and the central tube are formed together as one piece.

3. The filter element according to claim 1, wherein the valve cage is connected to at least one of the central tube and the support body at least by one connection selected from the group consisting of a detent connection, a snap connection, a plug-in connection, and a screw connection.

4. The filter element according to claim 1, wherein the valve cage comprises guide elements arranged at an inner side of the valve cage, wherein the guide elements are configured to axially guide the valve body.

5. The filter element according to claim 1, wherein a gap is formed between the screen and an outer diameter of the valve body.

6. The filter element according to claim 1, wherein the valve cage is fastened in the opening of the first end disk by one or more fastening actions selected from the group consisting of pressing, gluing, and screwing.

7. The filter element according to claim 1, wherein the valve cage and the first end disk are formed together as one piece.

8. The filter element according to claim 1, wherein at least one of the first and second end disks is comprised of plastic material and wherein at least one of the at least one hollow-cylindrical filter bellows and the central tube is glued to said at least one of the first and second end disks comprised of plastic material.

9. The filter element according to claim 8, wherein the at least one hollow-cylindrical filter bellows or the central tube is embedded by a liquid adhesive in said at least one of the first and second end disks comprised of plastic material.

10. The filter element according to claim 8, wherein the at least one hollow-cylindrical filter bellows and the central tube are embedded by a liquid adhesive in said at least one of the first and second end disks comprised of plastic material.

11. The filter element according to claim 1, wherein the filter element with the valve device can be operated opposite to a direction of gravity.

12. The filter element according to claim 1, wherein at least the first end disk is a film end disk and wherein at least one of the central tube and the valve cage is connected by a plug-in connection to the film end disk.

13. The filter element according to claim 12, wherein the plug-in connection is detachable.

14. The filter element according to claim 1, wherein the valve cage is a hollow cylinder comprising through openings, wherein the through openings are covered by the screen.

15. The filter element according to claim 1, wherein the support body comprises ribs extending in an axial direction along the longitudinal axis, wherein the ribs are configured to guide the valve cage.

16. The filter element according to claim 1, wherein the support body comprises a circumferentially extending shoulder, wherein the circumferentially extending shoulder is a spring support supporting the spring when the valve device is mounted as intended.

17. The filter element according to claim 1, wherein the support body is connected by radially extending ribs to the central tube.
